(19) United States
(12) Patent Application Publication
(10) Pub. No.: US 2016/0142723 A1
(43) Pub. Date: May 19, 2016

(54) FRAME DIVISION INTO SUBFRAMES

(71) Applicant: HEWLETT-PACKARD DEVELOPMENT COMPANY, L.P., Fort Collins, CO (US)

(72) Inventor: Derek Lukasik, Fort Collins, CO (US)

(21) Appl. No.: 14/898,260

(22) PCT Filed: Jun. 28, 2013
(86) PCT No.: PCT/US2013/048584

§ 371 Date: Dec. 14, 2015

(51) Int. Cl. H04N 19/436

(52) U.S. Cl. CPC H04N 19/436

(57) ABSTRACT

In an example, a device may include a division unit and a plurality of encoding units. The division unit may divide a video frame into a plurality of subframes. Each of encoding units may encode a corresponding one of the plurality of subframes. The division unit may determine a number of the subframes based on a number of the encoding units.

### BACKGROUND

Video frames may be encoded and transmitted. For example, a host may share video in real-time with one or more clients, such as during a presentation. The video may be encoded by the host before transmission and then decoded by the clients upon receipt. Encoding the video may significantly decrease a size of the video frames transmitted, resulting in lower bandwidth utilization.

### BRIEF DESCRIPTION OF THE DRAWINGS

The following detailed description references the drawings, wherein:

FIG. 1 is an example block diagram of a device to divide a video frame into a plurality of subframes;

FIG. 2 is another example block diagram of a device to divide a video frame into a plurality of subframes;

FIG. 3 is an example block diagram of a computing device including instructions for dividing a video frame into a plurality of subframes; and

FIG. 4 is an example flowchart of a method for dividing a video frame into a plurality of subframes.

### DETAILED DESCRIPTION

Specific details are given in the following description to provide an understanding of examples of the present techniques. However, it will be understood that examples of the present techniques may be practiced without these specific details. For example, systems may be shown in block diagrams in order not to obscure examples of the present techniques in unnecessary detail. In other instances, well-known processes, structures and techniques may be shown without unnecessary detail in order to avoid obscuring the examples of the present techniques.

Video encoding according to standards such as MPEG2 and h.264 may be very compute intensive. These compute requirements scale linearly with the size of the frames being processed. As frame size increases, the required computation time per frame also increases. Consequently, in a real-time system, the latency from frame to frame may also directly increase as frame size increases. The user experience for interactive applications that use real-time video degrades whenever the latency of the system increases.

Consider a distributed video processing system involving a sending system that is capturing video data and encoding it. The sending system transmits encoded data to a receiving system. The receiving system decodes each frame and displays the resulting video frame or processes it further. The typical encode/decode pipeline for such a system may involve a source feeding a single encoder.

Encoded data may then be passed to a receiver where it is decoded and displayed. The decoding system may also typically have a single decoder processing the incoming data. In such a system, latency may linearly increase as a function of input frame size in a video processing application. Given current trends for increasingly higher definition and/or larger frame sizes, the increased latency may be unacceptable for real-time interactivity.

Modem computer systems, workstations in particular, have many cores available. By distributing the work of encoding large video frames across the available cores in the system, examples of present techniques may decrease the latency induced by the video encoding process. The decrease in latency may be linearly proportional to the number of processor or cores used in the encode pipeline. For example, a device may include a division unit and a plurality of encoding units. The division unit may divide a video frame into a plurality of subframes. Each of encoding units may encode a corresponding one of the plurality of subframes. The division unit may determine a number of the subframes based on a number of the encoding units. Each of the encoding units may operate independently.

Thus, by allocating a portion of the available hardware resource to a video encode pipeline, examples may increase overall performance of a real-time video processing applications. Further, the performance benefits may scale linearly with the number of processors and/or cores available at the device. For instance, examples may divide the work for encoding each video frame among the available hardware resources. Dividing the video frame may allow encoding to proceed in parallel and reduce the latency required to produce each frame. This may have a direct impact on the performance of the system and thus improve the user experience and overall interactivity of the system.

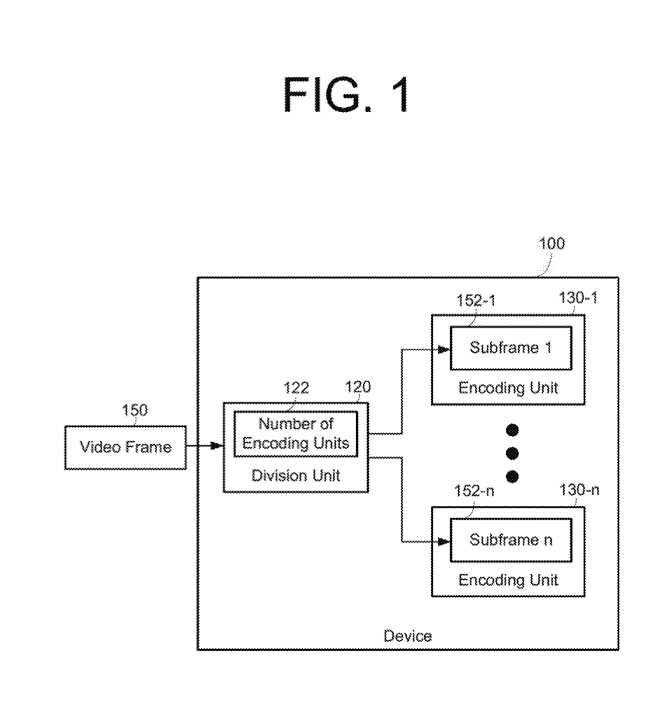

Referring now to the drawings, FIG. 1 is an example block diagram of a device 100 to divide a video frame 150 into a plurality of subframes 152-1 to 152-n. The device 100 may be any type of device to receive a video frame 150. Examples of the device 100 may be a part of or include a workstation, terminal, laptop, tablet, desktop computer, thin client, remote device, mobile device, server, hub, wireless device, recording device and the like.

In FIG. 1, the device 100 is shown to include a division unit 120 and a plurality of encoding units 130-1 to 130-n, where n is a natural number. The division unit 120 and the plurality of encoding units 130-1 to 130-n may include, for example, a hardware device including electronic circuitry for implementing the functionality described below, such as control logic and/or memory. In addition or as an alternative, the division unit 120 and the plurality of encoding units 130-1 to 130-n may be implemented as a series of instructions encoded on a machine-readable storage medium and executable by one or more processors.

The division unit 120 may divide the video frame 150 into the plurality of subframes 152-1 to 152-n. The video frame 150 may be a complete or partial image captured during a known time interval. A type of the video frame 150 that is used as a reference for predicting other video frames 150 may also be referred to as a reference frame. The subframes 152-1 to 152-n may define different and separate regions of the video frame 150. For example, if there four subframes 151-1 to 152-4, each of the subframes 151-1 to 152-4 may represent one quadrant of the video frame 150 to be displayed.

The division unit 120 may determine a number of the subframes 152-1 to 152-n based on a number of the plurality of encoding units 130-1 to 130-n. For example, if there are four encoding units 130-1 to 130-n, the division unit 120 may divide the video frame 150 into four subframes 152-1 to 152-4. The division unit 120 may divide the subframes 152-1 to 152-n to be approximately equal in size. The subframes 152-1 to 152-n may not overlap with respect to the video frame 150.

The number of the plurality of encoding units 130-1 to 130-n may be determined based on a number of the processors (not shown) included in the device 100. For example, if the device 100 has only 3 processors free to encode, then only 3 encoding units 130-1 to 130-3 may be formed, and thus the video frame 150 may be divided into only 3 subframes 152-1 to 152-3.

Each of encoding units 130-1 to 130-n may encode a corresponding one of the plurality of subframes 152-1 to 152-n. For example, if the video frame 150 is divided into four subframes 152-1 to 152-4, the first encoding unit 130-1 may encode the first subframe 152-1, the second encoding unit 130-2 may encode the second subframe 152-2, and so on. Each of the encoding units 130-1 to 130-n may operate independently and do not communicate with each other. Further, the plurality of encoding units 130-1 to 130-n may encode the subframes 152-1 to 152-n in parallel.

Each of the encoding units 130-1 to 130-n includes a separate encoder and/or a separate instance of the encoder (not shown). The term encoder may refer to a device, circuit, software program and/or algorithm that converts information from one format or code to another, for the purposes of standardization, speed, secrecy, security, or saving space by shrinking size. For example, the encoders included in the encoding units 130-1 to 130-n may be capable of capturing, compressing and/or converting audio/video.

A variety of methods may be used by the encoding units 130-1 to 130-n to compress or encode streams of video frames 150. For example, encoding units 130-1 to 130-n may compress the video frames 150 according to any of the following standards: H.120, H.261, MPEG-1 Part 2, H.262/MPEG-2 Part 2, H.263, MPEG-4 Part 2, H.264/MPEG-4, AVC, VC-2 (Dirac), H.265. MPEG-2 may be commonly used for DVD. Blu-ray and satellite television while MPEG-4 may be commonly used for AVCHD, Mobile phones (3GP) and videoconferencing and video-telephony.

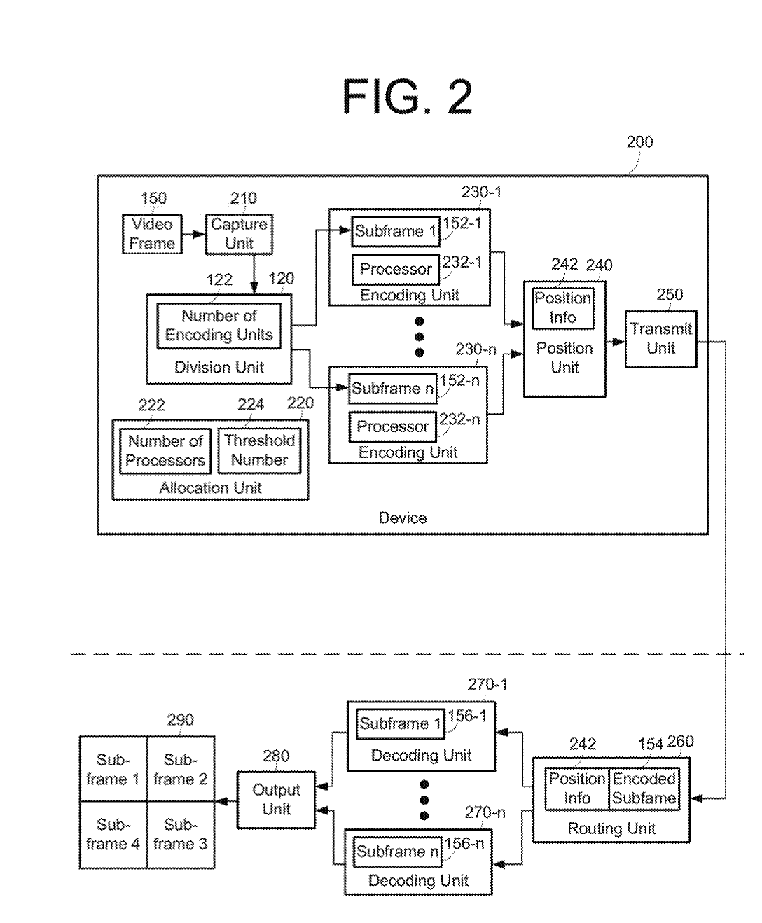

FIG. 2 is another example block diagram of a device 200 to divide the video frame 150 into the plurality of subframes 152-1 to 152-n. The device 200 may be any type of device to receive the video frame 150. Examples of the device 200 may be a part of or include a workstation, terminal, laptop, tablet, desktop computer, thin client, remote device, mobile device, server, hub, wireless device, recording device and the like.

The device 200 of FIG. 2 may include at least the functionality and/or hardware of the device 100 of FIG. 1. For example, the device 200 of FIG. 2 includes the division unit 120 and a plurality of encoding units 230-1 to 230-n that include the functionality of the encoding units 230-1 to 230-n of FIG. 1. The device 200 further includes a capture unit 210, an allocation unit 220, a position unit 240 and a transmit unit 250. The device 200 may also interface over a network with a system or other device to transmit the encoded subframes 152-1 to 152-n. This remote system or device may include a routing unit 260, a plurality of decoding units 270-1 to 270-n and an output unit 280.

The capture unit 210, allocation unit 220, position unit 240, transmit unit 250, routing unit 260, plurality of decoding units 270-1 to 270-n and output unit 280 may include, for example, a hardware device including electronic circuitry for implementing the functionality described below, such as control logic and/or memory. In addition or as an alternative, the capture unit 210, allocation unit 220, position unit 240, transmit unit 250, routing unit 260, plurality of decoding units 270-1 to 270-n and output unit 280 may be implemented as a series of instructions encoded on a machine-readable storage medium and executable by one or more processors.

The capture unit 210 may capture the video frame 150 to be encoded by the plurality of encoding units 230-1 to 230-n. The number of the encoding units 130-1 to 130-n may be based on a number of processors 232-1 to 232-n included in the device 200. Each of the encoding units 230-1 to 230-n may include a separate processor 232-1 to 232-n of the device 200. The term processor may refer to single-core processor or one of the cores of a multi-core processor. The multi-core processor may refer to a single computing component with two or more independent actual central processing units (called “cores”), which are the units that read and execute program instructions.

The allocation unit 220 to determine a number of the processors 222 included in the device 200 and may allocate a threshold number 224 of the processors 232-1 to 232-n to the encoding units 230-1 to 230-n. The threshold number 224 may be determined experimentally or according to preferences as well as based on numerous factors. For instance, the allocation unit 220 may determine that there are six processors 232-1 to 232-6 included in the device. The allocation unit 220 may seek to balance use of the six processors 232-1 to 232-6 between video encoding and other tasks. Here, the allocation unit 220 may determine that at least 2 processors 232-5 and 232-5 may be needed by the device 200 to adequately process non-encoding tasks. Thus, the threshold number 224 may be set to 4. In turn, each of the four processors 232-1 to 232-4 may be used to form a separate encoding unit 230-1 to 230-4, while the remaining two processors 232-5 and 232-6 may be dedicated to non-encoding tasks.

The position unit 240 may add position information 242 to each of the encoded subframes 154-1 to 154-n. The position information 242 may indicate a number of the subframe 154 and/or a location of the subframe 154 with respect to the video frame 150. For example, the position information 242 may provide coordinates of the subframe 154 within a bitmap. For instance, the position information 242 may include (x,y) positions of pixels within the subframe 154, corner or center positions of the subframe 154, dimensions of the subframe 154, a layout of the subframe(s) 154, and the like. In the case where there are 4 encoded subframes 154-1 to 154-4, the position information 242 may indicate whether the encoded subframe 154 belongs to an upper-left quadrant, an upper-right quadrant, a lower-left quadrant or a lower-right quadrant.

The transmit unit 250 of the device 200 may transmit the encoded subframes 154-1 to 154-n to the routing unit 260 of the remote system or device, such as over a network. The routing unit 260 may route each of encoded subframes 154-1 to 154-n to one of the decoding units 270-1 to 270-n based on the position information 242 of the subframes 152-1 to 152-n. For example, the routing unit 260 may send subframes 154 belonging to the upper-left quadrant to the first decoder 270-1, send subframes 154 belonging to an upper-right quadrant to the second decoder 270-2, and so on. Each of the plurality of decoding units 270-1 to 270-n may decode a corresponding one of the plurality of encoded subframes 154-1 to 154-n of the video frame 150. The output unit 280 to combine the plurality of decoded subframes 156-1 to 156-n into a single decoded frame 290 and may display the decoded frame 290.

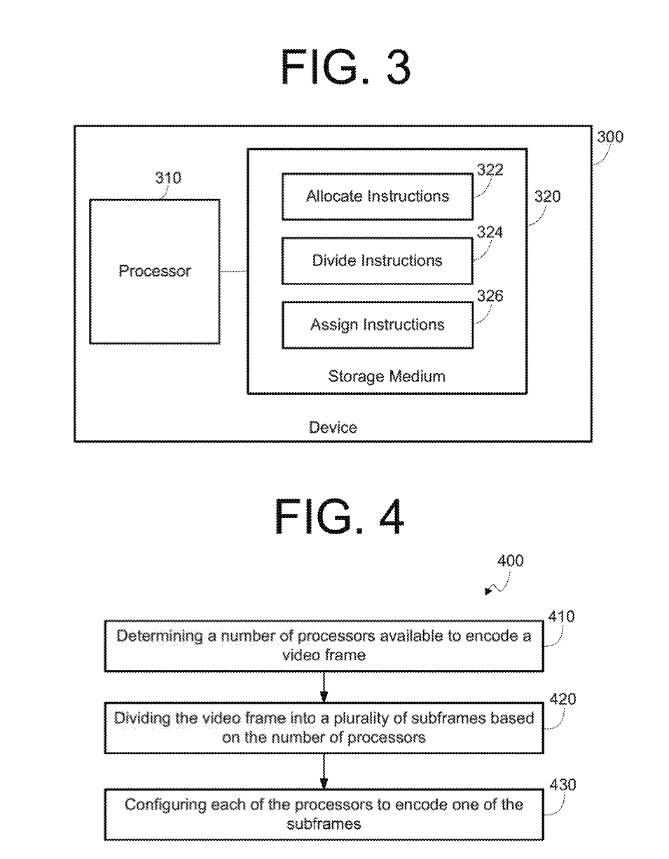

FIG. 3 is an example block diagram of a computing device 300 including instructions for dividing a video frame into a plurality of subframes. In the embodiment of FIG. 3, the computing device 300 includes a processor 310 and a machine-readable storage medium 320. The machine-readable storage medium 320 further includes instructions 322, 324 and 326 for dividing a video frame into a plurality of subframes.

The computing device 300 may be, for example, a secure microprocessor, a notebook computer, a desktop computer, an all-in-one system, a server, a network device, a wireless device, or any other type of user device capable of executing the instructions 322, 324 and 326. In certain examples, the computing device 300 may include or be connected to additional components such as memories, sensors, displays, etc.

The processor 310 may be, at least one central processing unit (CPU), at least one semiconductor-based microprocessor, other hardware devices suitable for retrieval and execution of instructions stored in the machine-readable storage medium 320, or combinations thereof. The processor 310 may fetch, decode, and execute instructions 322, 324 and 326 to dividing the video frame into the plurality of subframes. As an alternative or in addition to retrieving and executing instructions, the processor 310 may include at least one integrated circuit (IC), other control logic, other electronic circuits, or combinations thereof that include a number of electronic components for performing the functionality of instructions 322, 324 and 326.

The machine-readable storage medium 320 may be any electronic, magnetic, optical, or other physical storage device that contains or stores executable instructions. Thus, the machine-readable storage medium 320 may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium 320 can be non-transitory. As described in detail below, machine-readable storage medium 320 may be encoded with a series of executable instructions for dividing the video frame into the plurality of subframes.

Moreover, the instructions 322, 324 and 326 when executed by a processor (e.g., via one processing element or multiple processing elements of the processor) can cause the processor to perform processes, such as, the process of FIG. 4. For example, the allocate instructions 322 may be executed by the processor 310 to allocate a threshold number of a plurality of processors (not shown) to encoding a video frame (not shown), where the threshold number is greater than one. The threshold number may be determined based on a number of the plurality of processors to be dedicated non-encoding processes. For example, if the device 300 includes six processors and two of the processors are dedicated to non-encoding processes, the threshold number may be four (six minus two).

The divide instructions 324 may be executed by the processor 310 to divide the video frame into the threshold number of subframes (not shown). The assign instructions 326 may be executed by the processor 310 to assign each of the allocated processors to encode one of the subframes. Each of the allocated processors may encode independently of each other and in parallel using separate encoders.

FIG. 4 is an example flowchart of a method 400 for dividing a video frame into a plurality of subframes. Although execution of the method 400 is described below with reference to the device 200, other suitable components for execution of the method 400 can be utilized, such as the device 100. Additionally, the components for executing the method 400 may be spread among multiple devices (e.g., a processing device in communication with input and output devices). In certain scenarios, multiple devices acting in coordination can be considered a single device to perform the method 400. The method 400 may be implemented in the form of executable instructions stored on a machine-readable storage medium, such as storage medium 320, and/or in the form of electronic circuitry.

At block 410, the device 200 determines a number of processors 232-1 to 232-n available to encode a video frame 150. Determining the number of processors 232-1 to 232-n available may include determining a total number of processors 232 included in the device 200 and selecting a threshold number 224 of the total number of processors 232-1 to 232-n to be dedicated to encoding.

At block 420, the device 200 divides the video frame 150 into a plurality of subframes 152-1 to 152-n based on the number of processors 232-1 to 232-n. The dividing may further include adding position information 242 to each of the subframes 152-1 to 152-n. The position information 242 may indicate a number of the subframe 152-1 to 152-n and/or a location of the subframe 152-1 to 152-n with respect to the video frame 150.

At block 430, the device 200 configures each of the processors 232-1 to 232-n to encode one of the subframes 152-1 to 152-n. The processors 232-1 to 232-n encode the subframes 152-1 to 152-n in parallel. The dividing at block 420 may divide a plurality of the video frames 150 into subframes 152-1 to 152-n. For example, the device 200 may receive a stream of video frames 150. In this case, each of the processors 232-1 to 232-n may encode the same subframe 152-1 to 152-n of each of the video frames 150.

According to the foregoing, examples of present techniques provide a method and/or device for decreasing the latency induced by the video encoding process. For instance, examples may divide the work for encoding each video frame among the available hardware resources. Dividing the video frame may allow encoding to proceed in parallel and reduce the latency required to produce each frame. This may have a direct impact on the performance of the system and thus improve the user experience and overall interactivity of the system.

We claim:

1. A device, comprising:
a division unit to divide a video frame into a plurality of subframes; and
a plurality of encoding units, each of encoding units to encode a corresponding one of the plurality of subframes, wherein
the division unit is to determine a number of the subframes the video frame is to be divided into based on a number of the plurality of encoding units,
the number of the plurality of encoding units is based on a number of processors included in the device, and
each of the encoding units do not communicate with each other.

2. The device of claim 1, wherein,
each of the encoding units includes a separate one of the processors of the device, and
the plurality of encoding units are to encode the subframes in parallel.

3. The device of claim 2, further comprising:
an allocation unit to determine the number of the processors included in the device and to allocate a threshold number of the processors to the encoding units.

4. The device of claim 1, further comprising:
a position unit to add position information to each of the subframes, the position information to indicate at least one of a number of the subframe and a location of the subframe with respect to the video frame.

5. The device of claim 1, wherein,
the division unit divides the subframes to be approximately equal in size, and
the subframes do not overlap with respect to the video frame.

6. The device of claim 1, wherein,
each of the encoding units includes a separate instance of an encoder, and
each of the encoding units is to operate independently of each other.

7. A system, comprising:
the device of claim 1;
a plurality of decoding units, each of decoding units to decode a corresponding one of the plurality of subframes; and
a routing unit to route each of subframes to one of the decoding units based on the position information of the subframes.

8. The system of claim 7, further comprising:
a capture unit to capture the video frame to be encoded by the plurality of encoding units;
a transmit unit to transmit the encoded subframes to the routing unit; and
an output unit to combine the plurality of decoded subframes into a single decoded frame and to display the decoded frame.

9. A method, comprising:
determining a number of processors available to encode a video frame;
dividing the video frame into a plurality of subframes based on the number of processors; and
configuring each of the processors to encode one of the subframes,
wherein
the processors are to encode the subframes in parallel.

10. The method of claim 9, wherein the dividing further includes adding position information to each of the subframes, the position information to indicate at least one of a number of the subframe and a location of the subframe with respect to the video frame.

11. The method of claim 9, wherein the determining the number of processors available includes determining a total number of processors included in a device and selecting a threshold number of the total number of processors to be dedicated to encoding.

12. The method of claim 9, wherein,
the dividing divides a plurality of the video frames into subframes, and
each of the processors encode the same subframe of each of the video frames.

13. A non-transitory computer-readable storage medium storing instructions that, if executed by a processor of a device, cause the processor to:
allocate a threshold number of a plurality of processors to encoding a video frame, where the threshold number is greater than one;
divide the video frame into the threshold number of subframes; and
assign each of the allocated processors to encode one of the subframes, wherein
each of the allocated processors is to encode independently of each other.

14. The non-transitory computer-readable storage medium of claim 13, wherein each of the allocated processors encode in parallel using separate encoders.

15. The non-transitory computer-readable storage medium of claim 14, wherein the threshold number is determined based on a number of the plurality of processors to be dedicated non-encoding processes.
